(19) United States
(12) Patent Application Publication
(10) Pub. No.: US 2023/0026752 A1
(43) Pub. Date: Jan. 26, 2023

(54) NOVEL PROCESS FOR PREPARING A BONDING RESIN

(71) Applicant: Stora Enso OYJ, Helsinki (FI)

(72) Inventors: Ashar Zafar, Alta (SE); Jesper Ekström, Johanneshov (SE)

(73) Assignee: Stora Enso OYJ, Helsinki (FI)

(21) Appl. No.: 17/757,261

(22) PCT Filed: Dec. 16, 2020
(86) PCT No.: PCT/IB2020/061998

§ 371 Date: Jun. 13, 2022

(30) Foreign Application Priority Data
Dec. 20, 2019 (SE) 1951514-7

(51) Int. Cl. C08L 97/00; C08F 220/32; B32B 21/14; B27N 3/00

(52) U.S. Cl. CPC C08L 97/005; C08F 220/325; B32B 21/14; B27N 3/002; C08L 2201/54; C08L 2312/00

(57) ABSTRACT

The present invention relates to a process for preparing a bonding resin, wherein lignin is provided in the form of an aqueous solution and mixed with one or more of a crosslinker and optionally one or more additives. The bonding resin is useful for example in the manufacture of laminates, mineral wool insulation and wood products such as plywood, oriented strandboard (OSB), laminated veneer lumber (LVL), medium density fiberboards (MDF), high density fiberboards (HDF), parquet flooring, curved plywood, veneered particleboards, veneered MDF or particle boards.

### FIELD OF THE INVENTION

The present invention relates to a process for preparing a bonding resin, wherein lignin is provided in the form of an aqueous solution and mixed with one or more of a crosslinker selected from diglycidyl-, triglycidyl- or polyglycidyl-ether of a carbohydrate, diglycidyl-, triglycidyl- or polyglycidyl-ester of a carbohydrate, diglycidyl-ether or diglycidyl ester of salicylic acid, vanillic acid, or 4-hydroxybenzoic acid, an epoxidized or glycidyl substituted plant-based phenolic compound (such as tannin, cardanol, cardol, anacardic acid) or epoxidized plant-based oil (such as rapeseed oil, linseed oil, soy bean oil), tris(4-hydroxyphenyl) methane triglycidyl ether, N,N-bis(2,3-epoxypropyl)aniline, p-(2,3-epoxypropoxy-N,N-bis(2,3-epoxypropyl)aniline, diglycidyl ether of bis-hydroxymethylfuran, and a crosslinker having functional groups selected from diglycidyl amide, triglycidyl amide, polyglycidyl amide, diglycidyl ester, triglycidyl ester, polyglycidyl ester, diglycidyl azide, triglycidyl azide, polyglycidyl azide, diglycidyl methacrylate, triglycidyl methacrylate and polyglycidyl methacrylate; and optionally one or more additives. The bonding resin is useful for example in the manufacture of laminates, mineral wool insulation and wood products such as plywood, oriented strandboard (OSB), laminated veneer lumber (LVL), medium density fiberboards (MDF), high density fiberboards (HDF), parquet flooring, curved plywood, veneered particleboards, veneered MDF or particle boards. The bonding resin is also useful for example in composites, molding compounds, foundry applications and coatings for paper, wood or metal substrates.

### BACKGROUND

Lignin, an aromatic polymer is a major constituent in e.g. wood, being the most abundant carbon source on Earth second only to cellulose. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry.

Lignin, being a polyaromatic network has been extensively investigated as a suitable substitute for phenol during production of phenol-formaldehyde adhesives. These are used during manufacturing of laminate and structural wood products such as plywood, oriented strand board and fiberboard. During synthesis of such adhesives, phenol, which may be partially replaced by lignin, is reacted with formaldehyde in the presence of either basic or acidic catalyst to form a highly cross-linked aromatic resins termed novolacs (when utilizing acidic catalysts) or resoles (when utilizing basic catalysts). Currently, only limited amounts of the phenol can be replaced by lignin due to the lower reactivity of lignin.

One problem when preparing resins comprising lignin is the use of formaldehyde, when the lignin is used in formaldehyde-containing resins, such as lignin-phenol-formaldehyde resins. Formaldehyde based resins emit formaldehyde, which is a toxic volatile organic compound. The present and proposed legislation directed to the lowering or elimination of formaldehyde emissions have led to the development of formaldehyde free resin for wood adhesive applications.

Jingxian Li R. et al. (Green Chemistry, 2018, 20, 1459-1466) describes preparation of a resin comprising glycerol diglycidyl ether and lignin, wherein the lignin is provided in solid form. One problem with the technology described in the article is a long pressing time and high pressing temperature. The 3 plies plywood sample was pressed at 150° C. temperature for 15 minutes to fully cure the resins.

Engelmann G. and Ganster J. (Holzforschung, 2014, 68, 435-446) describes preparation of a biobased epoxy resin with low molecular weight kraft lignin and pyrogallol, wherein the lignin component consists of an acetone extraction from Kraft lignin.

### SUMMARY OF THE INVENTION

It has now surprisingly been found that it is possible to easily prepare a bonding resin in which the use of formaldehyde can be avoided. It has also been found that an improved bonding resin can be achieved by providing lignin in the form of a solution. Providing the lignin in the form of a solution speeds up the reaction significantly and hence reduces the pressing time and enables the use of a lower pressing temperature for curing the bonding resin, when manufacturing for example laminates, mineral wool insulation and wood products such as plywood, oriented strandboard (OSB), laminated veneer lumber (LVL), medium density fiberboards (MDF), high density fiberboards (HDF), parquet flooring, curved plywood, veneered particleboards, veneered MDF or particle boards. The bonding resin is also useful for example in composites, molding compounds, foundry applications and coatings for paper, wood or metal substrates.

The present invention is thus directed to a method for preparing a bonding resin, wherein an aqueous lignin solution is mixed with one or more of a crosslinker selected from epoxidized vanillic acid, epoxidized plant-based phenolic acids, epoxidized soybean oil, tris(4-hydroxyphenyl) methane triglycidyl ether, N,N-bis(2,3-epoxypropyl)aniline, p-(2,3-epoxypropoxy-N,N-bis(2,3-epoxypropyl)aniline, diglycidyl ether of bis-hydroxymethylfuran, and a crosslinker having functional groups selected from glycidyl amine, diglycidyl amine, triglycidyl amine, polyglycidyl amine, glycidyl amide, diglycidyl amide, triglycidyl amide, polyglycidyl amide, glycidyl ester, diglycidyl ester, triglycidyl ester, polyglycidyl ester, glycidyl azide, diglycidyl azide, triglycidyl azide, polyglycidyl azide, glycidyl methacrylate, diglycidyl methacrylate, triglycidyl methacrylate and polyglycidyl methacrylate.

The present invention is thus also directed to the bonding resin obtainable using the method described above and to the use of the bonding resin in the manufacture of laminates, mineral wool insulation and wood products such as plywood, oriented strandboard (OSB), laminated veneer lumber (LVL), medium density fiberboards (MDF), high density fiberboards (HDF), parquet flooring, curved plywood, veneered particleboards, veneered MDF or particle boards. The bonding resin according to the present invention may also be used in or for coatings, such as coatings applied on metal surfaces or wood or other substrates. The present invention is also directed to such laminates, mineral wool insulation and wood products such as plywood, oriented strandboard (OSB), laminated veneer lumber (LVL), medium density fiberboards (MDF), high density fiberboards (HDF), parquet flooring, curved plywood, veneered particleboards, veneered MDF or particle boards manufactured using the bonding resin. The bonding resin according to the present invention may also be used in the manufacture of composites, molding compounds, foundry applications and coatings for paper, wood or metal substrates.

### DETAILED DESCRIPTION

It is intended throughout the present description that the expression “lignin” embraces any kind of lignin, e.g. lignin originated from hardwood, softwood or annular plants. Preferably the lignin is an alkaline lignin generated in e.g. the Kraft process. Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%. Thus, the lignin used according to the method of the present invention preferably contains less than 10%, preferably less than 5% impurities. The lignin may then be separated from the black liquor by using the process disclosed in WO2006031175. The lignin may then be separated from the black liquor by using the process referred to as the LignoBoost process.

The epoxidized vanillic acid, epoxidized plant-based phenolic acids, epoxidized soybean oil, tris(4-hydroxyphenyl) methane triglycidyl ether, and a crosslinker having functional groups selected from diglycidyl amide, triglycidyl amide, polyglycidyl amide, diglycidyl ester, triglycidyl ester, polyglycidyl ester, diglycidyl azide, triglycidyl azide, polyglycidyl azide, diglycidyl methacrylate, triglycidyl methacrylate and polyglycidyl methacrylate used according to the present invention acts as a crosslinker. Together with the lignin, it results in an adhesive during curing. Typically, the bonding resin according to the present invention is applied to the surfaces of for example veneers, such as in the manufacture of plywood. When the veneers are pressed together under heating, the crosslinking in the bonding resin takes place, resulting in an adhesive.

An aqueous solution of lignin can be prepared by methods known in the art, such as by mixing lignin, alkali and water. The pH of the lignin solution is preferably in the range of from 10 to 14. Examples of alkali include sodium hydroxide, potassium hydroxide and mixtures thereof. The amount of alkali in the aqueous solution is preferably from 0.1 wt-% to 15 wt-% of the solution, such as from 0.1 wt-% to 10 wt-% of the solution.

The weight ratio between lignin (dry weight) and the total amount of a crosslinker selected from diglycidyl-, triglycidyl- or polyglycidyl-ether of a carbohydrate, diglycidyl-, triglycidyl- or polyglycidyl-ester of a carbohydrate, diglycidyl-ether or diglycidyl ester of salicylic acid, vanillic acid, or 4-hydroxybenzoic acid, an epoxidized or glycidyl substituted plant-based phenolic compound (such as tannin, cardanol, cardol, anacardic acid) or epoxidized plant-based oil (such as rapeseed oil, linseed oil, soy bean oil), tris(4-hydroxyphenyl) methane triglycidyl ether, N,N-bis(2,3-epoxypropyl)aniline, p-(2,3-epoxypropoxy-N,N-bis(2,3-epoxypropyl)aniline, diglycidyl ether of bis-hydroxymethylfuran, and a crosslinker having functional groups selected from diglycidyl amide, triglycidyl amide, polyglycidyl amide, diglycidyl ester, triglycidyl ester, polyglycidyl ester, diglycidyl azide, triglycidyl azide, polyglycidyl azide, diglycidyl methacrylate, triglycidyl methacrylate and polyglycidyl methacrylate is preferably in the range of from 0.1:10 to 10:0.1, such as from 1:10 to 10:0.3, such as from 5:10 to 5:0.3, such as from 1:10 to 10:1. The amount of lignin in the bonding resin is preferably from 5 wt-% to 50 wt-%, calculated as the dry weight of lignin and the total weight of the bonding resin.

The bonding resin may also comprise additives, such as urea, tannin, solvents, surfactants, dispersing agents and fillers.

The amount of urea in the bonding resin can be 0-40% preferably 5-20% calculated as the dry weight of urea and the total weight of the bonding resin.

A filler and/or hardener can also be added to the bonding resin. Examples of such fillers and/or hardeners include limestone, cellulose, sodium carbonate, and starch. The bonding resin may also comprise coupling agent. Coupling agents are for example silane-based coupling agents.

The reactivity of the lignin with the glycidyl ether can be increased by modifying the lignin by glyoxylation, etherification, esterification or any other method where lignin hydroxyl content or carboxylic content or amine content or thiol content is increased. Preferably, the lignin used according to the present invention is not modified chemically.

Other solvents that can be used in the bonding resins according to the present invention are glycerol, ethylene glycol, polyethylene glycol, propylene glycol, polypropylene glycol, sorbitol and/or any terminal diol having a linear carbon chain of 3-6 carbon atoms.

The aqueous lignin solution is preferably mixed with the crosslinker at room temperature, such as at a temperature of from 15° C. to 30° C. The mixing is preferably carried out for about 5 minutes to 2 hours. Preferably, the viscosity of the mixture is monitored during mixing, either continuously or by taking samples and determining the viscosity thereof.

In view of the above detailed description of the present invention, other modifications and variations will become apparent to those skilled in the art. However, it should be apparent that such other modifications and variations may be effected without departing from the spirit and scope of the invention.

1. A method for preparing a bonding resin, the method comprising:
mixing, to provide a bonding resin, an aqueous lignin solution with one or more crosslinkers selected from a group consisting of diglycidyl-, triglycidyl- or polyglycidyl-ether of a carbohydrate, diglycidyl-, triglycidyl- or polyglycidyl-ester of a carbohydrate, diglycidyl-ether or diglycidyl ester of salicylic acid, vanillic acid, or 4-hydroxybenzoic acid, an epoxidized or glycidyl substituted plant-based phenolic compound or epoxidized plant-based oil, tris(4-hydroxyphenyl) methane triglycidyl ether, N,N-bis(2,3-epoxypropyl)aniline, p-(2,3-epoxypropoxy-N,N-bis(2,3-epoxypropyl)aniline, diglycidyl ether of bis-hydroxymethylfuran, and a crosslinker having functional groups selected from a group consisting of glycidyl amine, diglycidyl amine, triglycidyl amine, polyglycidyl amine, glycidyl amide, diglycidyl amide, triglycidyl amide, polyglycidyl amide, glycidyl ester, diglycidyl ester, triglycidyl ester, polyglycidyl ester, glycidyl azide, diglycidyl azide, triglycidyl azide, polyglycidyl azide, glycidyl methacrylate, diglycidyl methacrylate, triglycidyl methacrylate and polyglycidyl methacrylate.

2. The method according to claim 1, wherein the one or more crosslinkers is selected from a group consisting of diglycidyl-, triglycidyl- or polyglycidyl-ether of a carbohydrate, diglycidyl-, triglycidyl- or polyglycidyl-ester of a carbohydrate, diglycidyl-ether or diglycidyl ester of salicylic acid, vanillic acid, or 4-hydroxybenzoic acid, an epoxidized or glycidyl substituted plant-based phenolic compound or epoxidized plant-based oil, tris(4-hydroxyphenyl) methane triglycidyl ether, N,N-bis(2,3-epoxypropyl)aniline, p-(2,3-epoxypropoxy-N,N-bis(2,3-epoxypropyl)aniline, and diglycidyl ether of bis-hydroxymethylfuran.

3. The method according to claim 1, wherein the one or more crosslinkers has functional groups selected from a group consisting of glycidyl methacrylate, diglycidyl methacrylate, triglycidyl methacrylate, and polyglycidyl methacrylate.

4. The method according to claim 1, wherein the aqueous lignin solution is an alkali solution.

5. The method according to claim 1, wherein a weight ratio between lignin, calculated on a basis of dry lignin, and a total amount of crosslinker is from 0.1:10 to 10:0.1.

6. The method according to claim 1, wherein the aqueous lignin solution further comprises an additive, and wherein the additive is selected from a group consisting of urea, tannin, surfactant, dispersing agent, filler, coupling agent, a solvent, and combinations thereof.

7. The method according to claim 5, wherein the solvent is glycerol, ethylene glycol, polyethylene glycol, propylene glycol, polypropylene glycol, sorbitol, glycol ethers, alcohol, or a terminal diol having a linear carbon chain of 3-6 carbon atoms.

8. The method according to claim 1, wherein lignin in the aqueous lignin solution is modified by glyoxylation, etherification, esterification or any other method where a lignin hydroxyl content or amine content or thiol content is increased.

9. The method according to claim 1, wherein lignin in the aqueous lignin solution is not chemically modified before being used in the method.

10. A bonding resin obtained by the method of claim 1.

11. The method of claim 1 further comprising:
manufacturing a laminate, mineral wool insulation, or wood product with the bonding resin.

12. The method of claim 1 further comprising:
providing the bonding resin to a surface in the preparation of a laminate, mineral wool insulation, or wood product, and
curing of the bonding resin to form an adhesive when the surface is exposed to pressure and heating.

13. A laminate, mineral wool insulation, or wood product comprising the bonding resin according to claim 10.

14. The method of claim 1 wherein the aqueous lignin solution further comprises an additive.
